(19) United States
(12) Patent Application Publication
(10) Pub. No.: US 2012/0256443 A1
(43) Pub. Date: Oct. 11, 2012

(54) HINGE CLOSEOUT FOR A VEHICLE

(75) Inventors: PAUL A. RINE, ELKHART, IN (US); ROD R. RODRIGUEZ, ELKHART, IN (US)

(73) Assignee: UTILIMASTER CORPORATION, Wakarusa, IN (US)

(21) Appl. No.: 13/440,138

(22) Filed: Apr. 5, 2012

Related U.S. Application Data
(60) Provisional application No. 61/471,829, filed on Apr. 5, 2011.

(51) Int. Cl. B60J 5/00

(52) U.S. Cl. 296/146.11

(57) ABSTRACT

An illustrative embodiment of the present disclosure provides a cargo vehicle that includes a body with operator cabin and enclosed cargo area sections. The cargo area is located behind the operator cabin and includes at least one swing door hingedly attached to the body of the cargo area. The door is configured to swing open and closed via a hinge attached to both the swing door and to the body. When the swing door is open a longitudinal gap is formed between the body and the swing door. A longitudinally extending closeout panel is located over at least a portion of that longitudinal gap and coupled to both the swing door and body inside the cargo vehicle. The closeout panel is configured to fold to the interior of the cargo vehicle when the swing door is closed and expand when the swing door is opened.

### RELATED APPLICATIONS

The present application is related to and claims priority to U.S. Provisional Patent Application, Ser. No. 61/471829, filed on Apr. 5, 2011, entitled “Hinge Closeout For A Vehicle.” To the extent not included below, the subject matter disclosed in that application is hereby expressly incorporated into the present application.

### TECHNICAL FIELD AND SUMMARY

The present disclosure relates to delivery vehicles. More particularly, the present disclosure relates to a barrier that covers the space or slot between the delivery vehicle's body and door to prevent fingers from fitting into that space or slot and possibly being injured when the door closes.

Delivery vehicles typically include forward cab and rearward cargo sections or areas. A typical cargo area is sized to hold packages, supplies, uniforms, etc. for pickup and delivery. Such delivery vehicles are commonly used by such companies as UPS, Cintas, Arimark, FedEx, and Unifirst. The rear of the cargo area portion of the vehicle may be configured with a swing-type door.

Regarding swing-type doors, they are each typically attached to the vehicle via a plurality of hinges, not unlike conventional hinges on swing doors attached to a house or building. The hinges allow the attached door to swing between open and closed positions. Often, three hinges are used but it is contemplated that more or less hinges may be used depending on the particular need and size of vehicle and door. A conventional door hinge includes three parts—a door wing; a frame wing; and a pin. One of the wings includes one knuckle set while the other wing includes two knuckle sets. The two knuckle set straddles the one knuckle forming a tube through which the pin is disposed. This connection creates both a pivot axis for the door as well as a securement to hold the door to the body.

As is conventional with many types of hinged swing doors, a gap or opening is formed between the door and the edge of the body when the door is open. The knuckles and hinge occupy space creating this gap. And although this gap is needed for the proper operation of the door, it may pose a danger to the vehicle's operator. A characteristic of operating a delivery vehicle is the need for the operator to enter and exit the cargo area of the vehicle quite often. In the case of a package delivery vehicle, for example, every stop means delivering a package and each package delivery means possibly opening the swing doors at the rear of the cargo area, climbing inside, retrieving the package, exiting the cargo area and then delivering the package. The opening or gap between the door and the vehicle body may be in close proximity to the operator's hand while entering or exiting the cargo area. Indeed, under certain circumstances the operator's hands maybe in the specific vicinity of the gap. This repetitive entering and exiting increases the risk of getting fingers caught in the gap.

An illustrative embodiment of the present disclosure includes a barrier to prevent fingers from physically entering the opening. Illustratively, a closeout is disclosed that includes a longitudinally-extending, flexible panel having a first longitudinal edge and a second longitudinal edge wherein the first longitudinal edge has fasteners disposed therethrough sufficient to attach to the interior end of the cargo area body at the cargo door opening. The other longitudinal side of the panel includes fasteners that attach to the edge of the swing door at the hinged side. The panel covers a large portion of the opening between the door and body, particularly where the operator is most likely to grab preventing the operator's fingers from entering the opening. In an illustrative embodiment, the closeout panel includes seams or folds so it will behave in a predetermined way as the door opens and closes. For example, the panel may include a longitudinally-extending seam in its generally central area, or be a flat panel that folds when the door moves. This allows the closeout to fold up out of the way while the door is closing and then expand and cover the opening while the door is open. In one illustrative embodiment, the closeout may include a notch or similar-type removal of material to enable it to accommodate door hinges and not get in the way.

Another illustrative embodiment of the present disclosure provides a vehicle in a cargo vehicle configuration that includes a body with operator cabin and enclosed cargo area sections. The cargo area is located behind the operator cabin and includes at least one swing door hingedly attached to the body of the cargo area. The door is configured to swing open and closed thereby allowing selective access to the cargo area. A hinge is attached to the swing door and to the body. When the swing door is closed a seam is formed between the body and the swing door, and when the swing door is open a longitudinal gap is formed between the body and the swing door. A longitudinally extending closeout panel is located over at least a portion of the longitudinal gap and coupled to both the swing door and body inside the cargo vehicle. The closeout panel is configured to fold to the interior of the cargo vehicle when the swing door is closed and expand when the swing door is opened. The closeout panel is also configured to fold in a repeatable manner that does not interfere with closing and opening of the swing door.

In the above and other illustrative embodiments the vehicle may further comprise: the closeout panel including first and second longitudinally extending flange members with longitudinally extending first and second folded panels located there between, wherein the first and second folded panels join at a longitudinally extending fold line, and wherein the first folded panel extends to the first flange member and the second folded member extends to the second flange member; the closeout panel being wider than the gap; the swing door swinging horizontally whereas the longitudinally extending gap extending vertically; the at least one swing door including a pair of swing doors, each with longitudinally extending gaps when the doors are open, and both include the closeout panel; the closeout panel including a cutout formed therein sized to receive the hinge such that operation of the closeout does not interfere operation of the hinge; the closeout panel being made of rubber, or rubber-like material such as a fiber-reinforced rubber; and the closeout panel being attached to the swing door and body with fasteners.

Additional features and advantages of the hinge closeout will become apparent to those skilled in the art upon consideration of the following detailed descriptions exemplifying the best mode of carrying out the hinge closeout as presently perceived.

### BRIEF DESCRIPTION OF THE DRAWINGS

The present disclosure will be described hereafter with reference to the attached drawings which are given as non-limiting examples only:

FIG. 1 is a perspective view of a delivery vehicle with a cargo area;

FIG. 2 is a rear view of vehicle of FIG. 1 with swing doors in a closed position;

FIG. 3 is a PRIOR ART perspective view of a door at the rear of a delivery vehicle swung out to an open position;

FIG. 4 is another perspective rear view of the delivery vehicle of FIG. 1 with its swing door located in the open position;

FIG. 5 is a rear view of the cargo area portion of the delivery vehicle of FIG. 1 with its swing doors in the open position;

FIG. 6 is an end view of an illustrative embodiment of a hinge closeout panel;

FIG. 7 is a side view of the hinge closeout panel;

FIG. 8 is an interior view of the cargo area of the vehicle of FIG. 1 showing how the closeout folds into the interior of the cargo area;

FIG. 9 is a detail rear perspective view of the delivery vehicle with its swing door located in the open position;

FIG. 10 is a top view of an illustrative embodiment of a closeout; and

FIG. 11 is an end view of the closeout of FIG. 10.

Corresponding reference characters indicate corresponding parts throughout the several views. The exemplification set out herein illustrates embodiments of the hinge closeout, and such exemplification is not to be construed as limiting the scope of the hinge closeout in any manner.

### DETAILED DESCRIPTION OF THE DRAWINGS

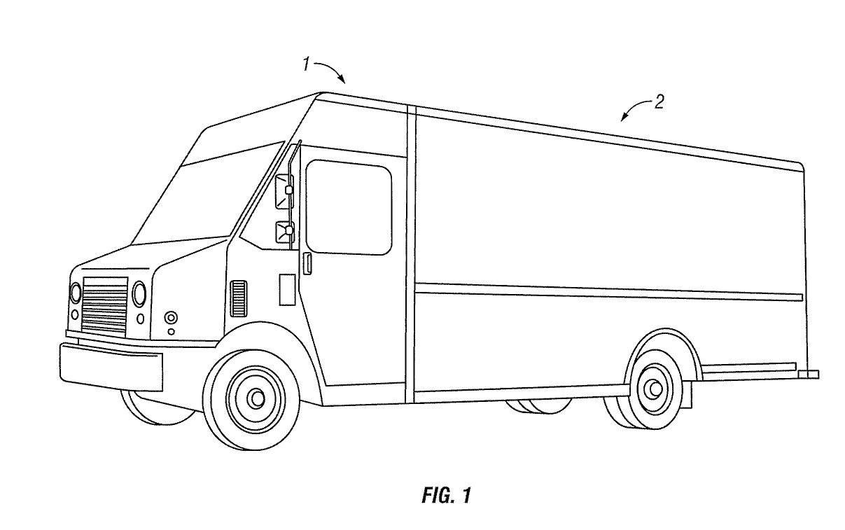

A perspective view of a delivery vehicle 1 with a cargo area 2 is shown in FIG. 1. It is this type of vehicle that starts and stops frequently and has a cargo area to access frequently from the rear for loading and unloading articles such as packages, uniforms, food, etc.

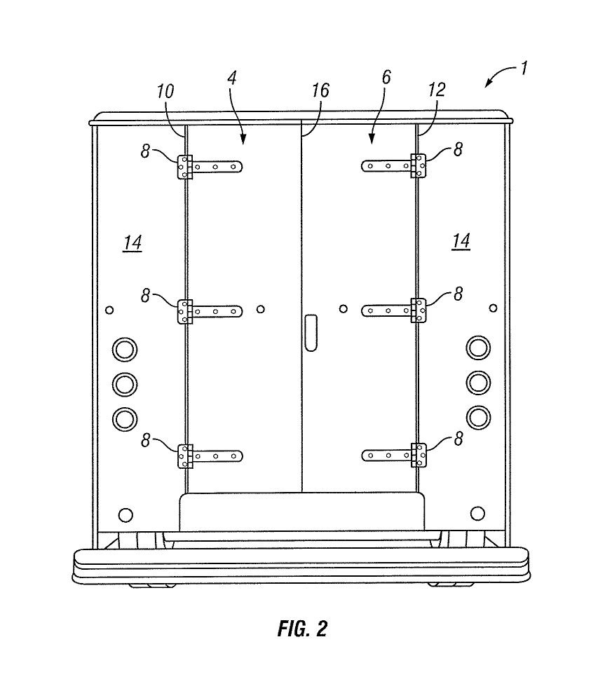

A rear view of vehicle 1 with swing doors 4 and 6 is shown in FIG. 2. Identifying swing doors is easy by virtue of hinges 8 on doors 4 and 6 at the rear of vehicle 1. Hinges 8 straddle seams 10 and 12 between swing doors 4 and 6, respectively, and body 14 of cargo area 2. There is also a seam 16 formed when the doors are closed indicating the separation between doors 4 and 6.

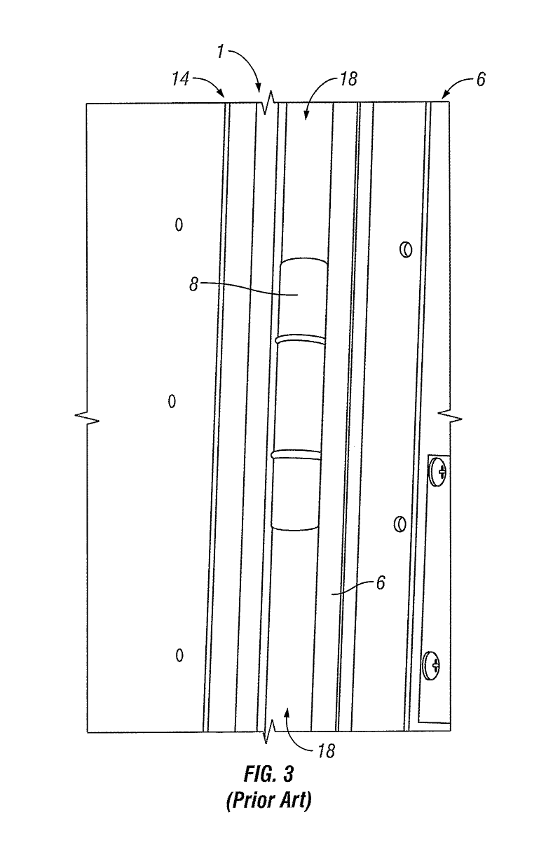

A perspective view of door 6 at the rear of delivery vehicle 1 swung out to an open position is shown in the PRIOR ART view of FIG. 3. This view shows how seam 12 from FIG. 2 now becomes a gap 18. This space forming gap 18 is created by the hinge configuration along with the separation of door 6 (or door 4 for that matter) from body 14. Gap 18 is large enough so that fingers may be inserted between door 6 (or door 4 for that matter) and body 14. A problem with all of this is that when the swing doors close, gap 18 becomes seam 12 again. In other words, gap 18 closes. If fingers are left in gap 18 while the door is closing, obviously they can be pinched causing injury.

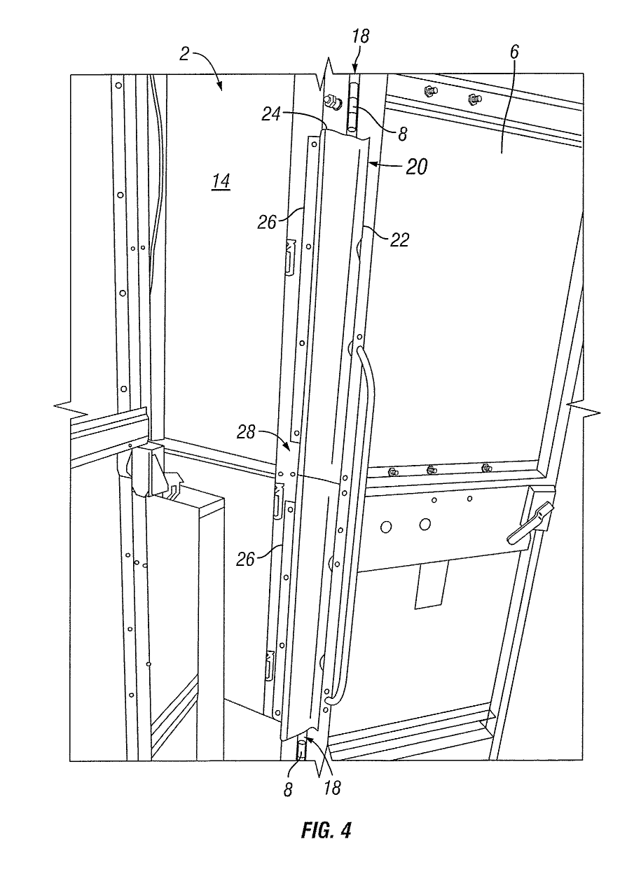

Another perspective rear view of delivery vehicle 1 with swing door 6 in the open position is shown in FIG. 4. In this case, however, a hinge closeout panel 20 longitudinally extends over at least a portion of gap 18. Panel 20 covers gap 18 so that an operator's fingers will not accidently find their way into gap 18 while entering or exiting cargo area 2. In other words, panel 20 acts as a barrier. The precise positioning of panel 20 over gap 18 and how much of gap 18 is covered may be adjustable. The location depends upon where the gap is located and where it is likely an operator may place his or her fingers in the gap. For instance, panel 20 may extend the entire length of door 6 shrouding the entire gap 18. Or, as shown, panel 20 may cover only that portion of the gap where the operator may put his or her fingers when entering or exiting cargo area 2.

As shown in the illustrative embodiment, first flange portion 22 is fastened to door 6. A longitudinally-extending, body portion 24 extends from first flange portion 22 covering slot 18. Second flange portion 26 illustratively extending from body portion 24 attaches or is fastened to body 14. In an illustrative embodiment, panel 20 is made from a flexible material such as rubber or other like materials. Body portion 24 is also illustratively sized so that door 6 (or door 4 for that matter) may close, also closing gap 18 to form seam 12. Second flange portion 26 may also include cutout 28 that avoid interfering with the hinge, particularly the knuckles of the hinge.

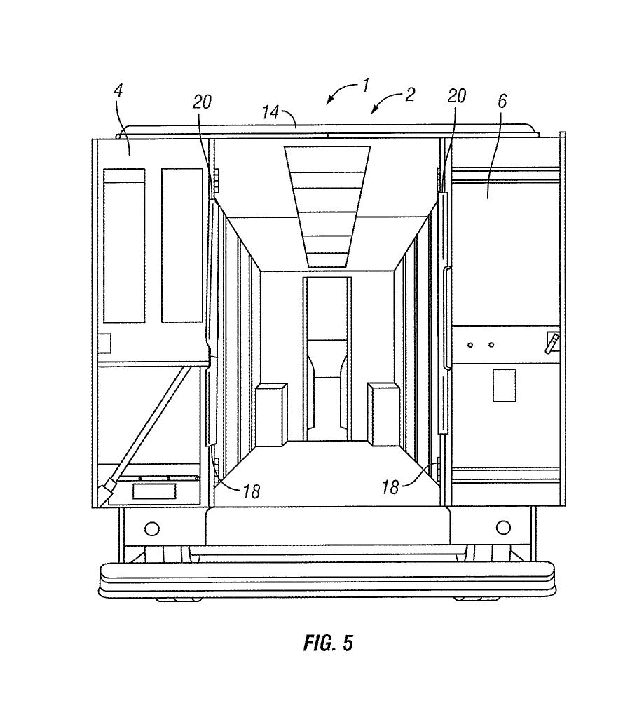

A rear view of cargo area 2 from delivery vehicle 1 with doors 4 and 6 in the open position is shown in FIG. 5. This view depicts closeout panel 20 covering gap 18 on each of the doors 4 and 6. This view also demonstrates how an operator may climb into cargo area 2 and not have to worry about getting his or her fingers caught in either gaps 18 between doors 6 and 4, respectively, and body 14 while entering or exiting the vehicle.

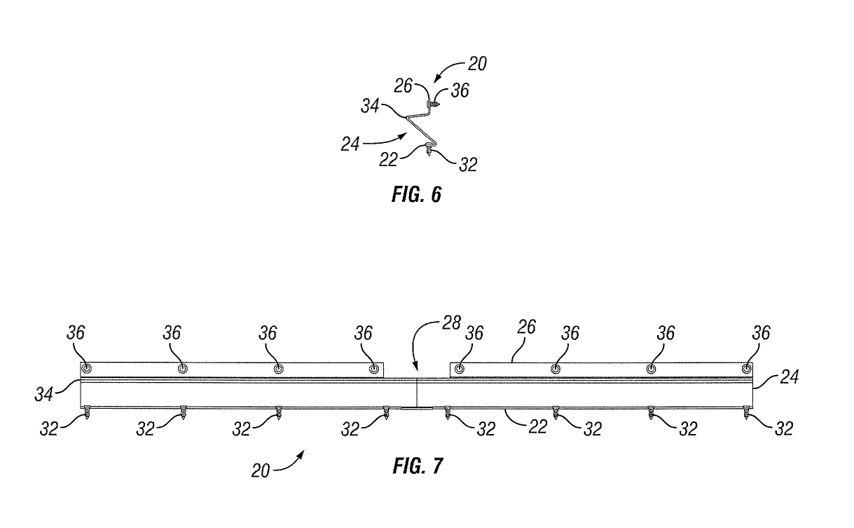

An end view of an illustrative embodiment of hinge closeout panel 20 is shown in FIG. 6. As shown, first flange portion 22 accommodates fasteners 32 configured to attach panel 20 to door 6. Body portion 24 of panel 20 is illustratively folded over as shown herein to accommodate the movement of door 6 toward and away from body 14 as demonstrated by seam 12 gap 18. This makes the body portion of panel 20 wider than the gap it shrouds. By folding along line 34, panel 20 will fold in a repeatable manner that does not interfere with the normal operation of door 6 (or door 4 for that matter) closing and opening. Second flange portion 26 includes fasteners 36 for attaching panel 20 to body 14. It is appreciated that a plurality of fasteners 32 and 36 may be positioned along the length of door 6 and body 14, respectively, to hold panel 20 in place.

A side view of hinge closeout panel 20 is shown in FIG. 7. This view shows how panel 20 is longitudinally extending. The plurality of fasteners 32 and 36 are shown positioned along the longitudinal extent of first flange portion 22 and second flange portion 26, respectively. Also shown in this view is cutout 28, previously discussed.

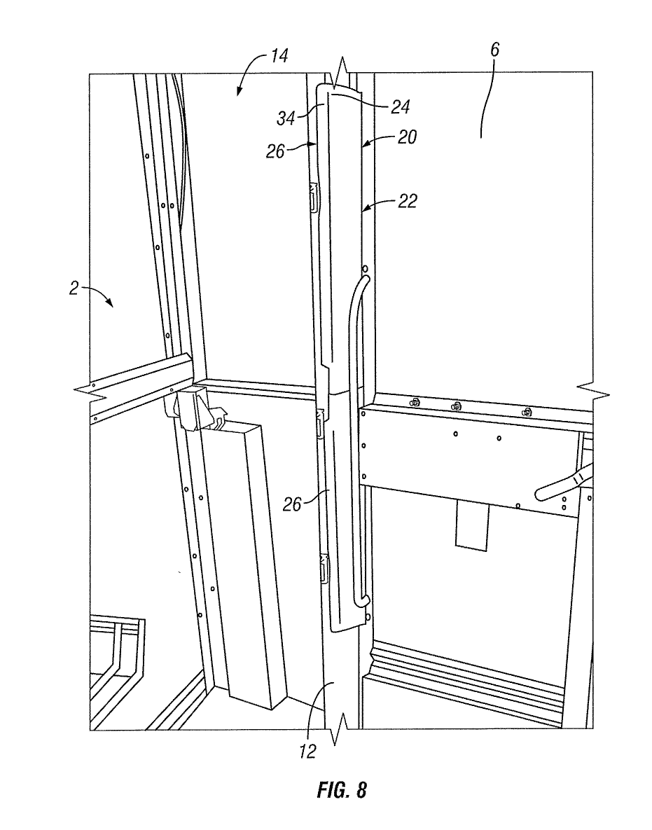

An interior view of cargo area 2 of vehicle 1 is shown in FIG. 8. This view shows door 6 in the closed position with hinge closeout panel 20 shrouding a portion of seam 12. It is appreciated from this view how line 34 folds panel 20 keeping body 24 from interfering with the closure of door 6. Instead, it remains out of the way but in position to expand when door 6 is opened again.

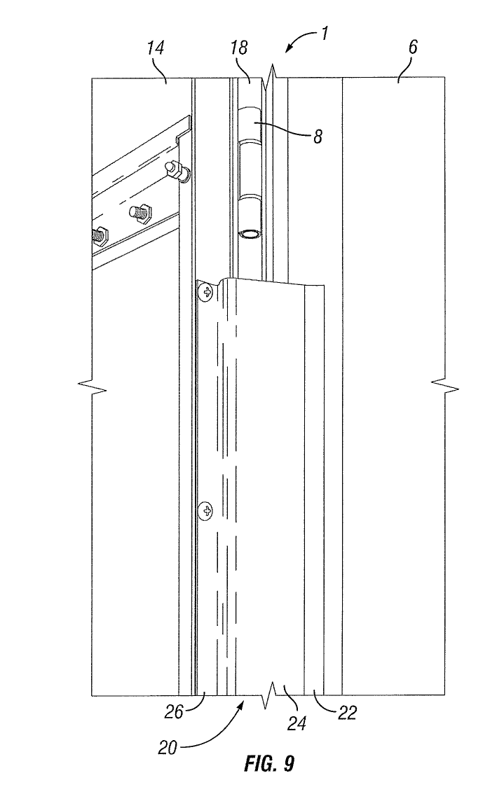

A detail rear perspective view of delivery vehicle 1 with swing door 6 in the open position is shown in FIG. 9. Hinge closeout panel 20 longitudinally extends over at least a portion of gap 18. First flange portion 22 is fastened to door 6. The longitudinally-extending body portion 24 extends from first flange portion 22 covering slot 18. Second flange portion 26 extends from body portion 24 fastening to body 14. As shown, body portion 24 is illustratively sized so that door 6 (or door 4 for that matter) may close without interference from panel 20.

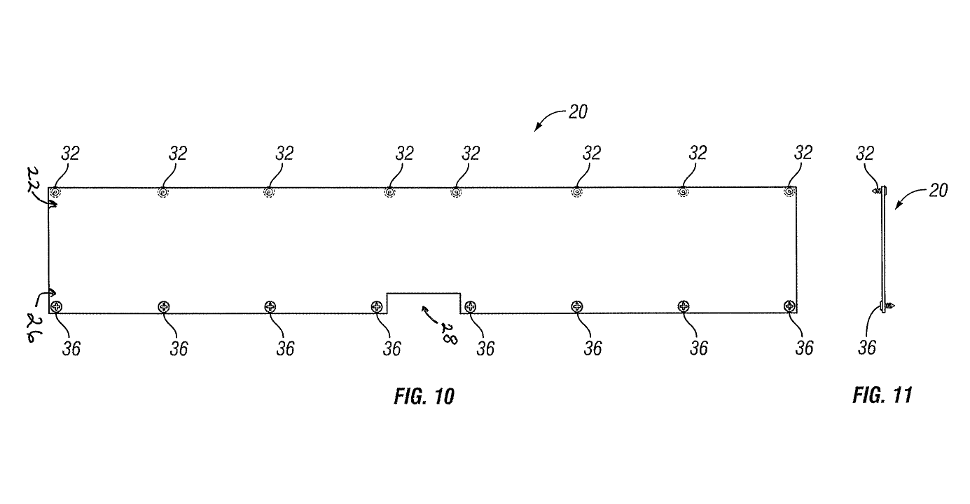

Another side view of hinge closeout panel 20 in expanded flat configuration is shown in FIG. 10. This view illustratively shows the positioning of fasteners 32 and 36 along the longitudinal extent. Also shown in this view is cutout 28, previously discussed. This embodiment is illustratively flat with no preformed seams. It can also be made of a fiber-reinforced rubber. The end view of hinge closeout panel 20 also in flatten is shown in FIG. 11.

Corresponding reference characters indicate corresponding parts throughout the several views. The exemplification set out herein illustrates various embodiments, and such exemplifications are not to be construed as limiting their scope in any manner.

What is claimed:

1. A vehicle comprising:
Cargo vehicle configuration that includes a body with operator cabin and enclosed cargo area sections;
wherein the cargo area is located behind the operator cabin;
wherein the cargo area includes at least one swing door hingedly attached to the body of the cargo area configured to swing open and close to allow selective access to the cargo area;
a hinge attached to the swing door and to the body wherein when the swing door is closed a seam is formed between the body and the swing door, and when the swing door is open a longitudinal gap is formed between the body and the swing door;
a longitudinally extending closeout panel located over at least a portion of the longitudinal gap and coupled to both the swing door and body inside the cargo vehicle;
wherein the closeout panel is configured to fold to the interior of the cargo vehicle when the swing door is closed and expand when the swing door is open; and
wherein the closeout panel is configured to fold in a repeatable manner that does not interfere with closing and opening of the swing door.

2. The vehicle of claim 1, wherein the closeout panel includes first and second longitudinally extending flange members with longitudinally extending first and second folded panels located there between, wherein the first and second folded panels join at a longitudinally extending fold line, and wherein the first folded panel extends to the first flange member and the second folded member extends to the second flange member.

3. The vehicle of claim 1, wherein the closeout panel is wider than the gap.

4. The vehicle of claim 1, wherein the swing door swings horizontally whereas the longitudinally extending gap extends vertically.

5. The vehicle of claim 1, wherein the at least one swing door includes a pair of swing doors, each with longitudinally extending gaps when the doors are open, and both include the closeout panel.

6. The vehicle of claim 1, wherein the closeout panel includes a cutout formed therein sized to receive the hinge such that operation of the closeout does not interfere operation of the hinge.

7. The vehicle of claim 1, wherein the closeout panel is made of rubber.

8. The vehicle of claim 1, wherein the closeout panel is attached to the swing door and body with fasteners.
